(19) United States
(12) Patent Application Publication
(10) Pub. No.: US 2025/0010942 A1
(43) Pub. Date: Jan. 9, 2025

(54) HUMAN-DRIVEN VEHICLE AND DRIVE CONTROL APPARATUS

(71) Applicant: YAMAHA HATSUDOKI KABUSHIKI KAISHA, Iwata-shi (JP)

(72) Inventors: Hisashi WATANABE, Shizuoka (JP); Mikio SAITOU, Shizuoka (JP); Tatsunori SHIMIZU, Shizuoka (JP)

(21) Appl. No.: 18/762,085

(22) Filed: Jul. 2, 2024

(30) Foreign Application Priority Data
Jul. 4, 2023 (JP) 2023-109856

(51) Int. Cl. B62M 6/50; B62J 45/411; B62J 45/412

(52) U.S. Cl. CPC B62M 6/50; B62J 45/411; B62J 45/412

(57) ABSTRACT

A vehicle includes wheels, a motor, pedals, a vehicle speed sensor, and a drive controller configured or programmed to control driving of the motor and to perform an automatic control using a driving force from the motor alone when at least a first precondition is met in which the rider is riding the vehicle and traveling, and the vehicle speed has reached a set speed by acceleration being not only due to a driving force from the motor.

### CROSS-REFERENCE TO RELATED APPLICATION

This application is based upon and claims the benefit of priority to Japanese Patent Application No. 2023-109856, filed on Jul. 4, 2023, the entire contents of which are hereby incorporated herein by reference.

### BACKGROUND OF THE INVENTION

### 1. Field of the Invention

The present invention relates to control of vehicles each including a motor and pedals.

### 2. Description of the Related Art

Japanese Patent No. 3849452 describes an electric motor assisted bicycle featuring a control circuit that includes an automatic speed control function for switching to a predetermined speed when the running speed is not lower than 15 km/h, and an automatic torque control function for switching to a predetermined torque when the running speed is not higher than 15 km/h. The automatic speed control function assists the rider by supplementing his/her pedal force with a motor torque such that the bicycle is controlled at a constant speed.

Japanese Patent No. 6226825 discloses an electric motor assisted bicycle that performs assistance when the user is not riding the electric motor assisted bicycle and moving the electric motor assisted bicycle by pushing it. It specifies a first state of the electric motor assisted bicycle in which a vehicle speed is being generated without relying on a pedal force; when the user in the first state operates an operation unit, the motor controls the bicycle such that, from the time of the user operation of the operation unit onward, a first vehicle speed, which is the speed at the time of the operation, is maintained.

### SUMMARY OF THE INVENTION

Example embodiments of the present invention disclose vehicles that efficiently reduce the burden of producing a pedal force on the rider during traveling.

A vehicle according to an example embodiment of the present invention includes a plurality of wheels, a motor to supply at least one of the plurality of wheels with a driving force, a pedal to receive application of a pedal force applied by a rider to drive at least one of the plurality of wheels, a vehicle speed sensor to detect a vehicle speed, and a drive controller configured or programmed to control driving of the motor. The drive controller performs an automatic control when at least a first precondition is met in which the rider is riding the human driven vehicle and traveling, the vehicle speed detected by the vehicle speed sensor has reached a set speed by acceleration being not only due to a driving force from by the motor, the automatic control controlling the vehicle speed using the driving force from the motor alone.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a left side view of a vehicle according to an example embodiment of the present invention.

FIG. 2 is a block diagram illustrating an exemplary mechanical and electrical connection configuration of the components of the vehicle shown in FIG. 1.

FIG. 3A illustrates an exemplary implementation with a normal assist control and an automatic control by a drive controller, and FIG. 3B illustrates a scenario with the normal assist control only.

FIG. 4 illustrates another exemplary implementation with a normal assist control and an automatic control by a drive controller.

FIG. 5 is a flow chart illustrating an exemplary automatic control process by a drive controller.

FIG. 6 is a flow chart illustrating an exemplary process of step S8 (i.e., calculation of the output in a gradual decrease mode) in FIG. 5.

FIG. 7 is a flow chart illustrating another exemplary process of step S8 (i.e., calculation of the output in the gradual decrease mode) in FIG. 5.

FIG. 8 is a graph illustrating patterns of changes in vehicle speed over time in the gradual decrease mode.

FIG. 9 is a graph illustrating patterns of changes in vehicle speed over time when the vehicle is traveling on downward slopes.

FIG. 10 is a graph illustrating patterns of changes in vehicle speed over time when the vehicle is traveling on a level road, a downward slope, and then another level road.

FIGS. 11A and 11B show graphs illustrating patterns of changes in vehicle speed over time when the vehicle is traveling on a level road, an upward slope, and then another level road.

### DETAILED DESCRIPTION OF THE EXAMPLE EMBODIMENTS

A human driven vehicle according to an example embodiment of the present invention includes a plurality of wheels, a motor to supply at least one of the plurality of wheels with a driving force, a pedal to receive application of a pedal force applied by a rider to drive at least one of the plurality of wheels, a vehicle speed sensor to detect a vehicle speed, and a drive controller configured or programmed to control driving of the motor. The drive controller is configured or programmed to perform an automatic control using the driving force from the motor alone when at least a first precondition is met in which, while the rider is riding the human driven vehicle and traveling, the vehicle speed detected by the vehicle speed sensor has reached a set speed by acceleration being not only due to a driving force from the motor.

In the arrangement above, while the rider is riding the vehicle and traveling and when the vehicle speed has reached a set vehicle speed without relying solely on a driving force generated by the motor, the drive controller automatically controls the vehicle speed by the motor even when no pedal force is being input to the pedals. Thus, until a set vehicle speed is reached, the vehicle speed may be increased by not only the motor but also other factors such as a pedal force and a downward slope, and, after the set vehicle speed has been reached, the vehicle speed can be automatically controlled without relying on a pedal force. This efficiently reduces the burden of producing a pedal force on the rider during traveling. For example, when the rider puts effort into pedaling and thus reaches a set vehicle speed, an automatic control is possible that maintains the vehicle speed or reduces or prevents a speed decrease.

In the above arrangement, the first precondition is met if a set vehicle speed has been reached due to, for example, an acceleration produced by a pedal force applied by the rider only, a pedal force applied by the rider plus an assisting motor driving force, or external factors such as a downward slope or a tail wind. Thus, the rider achieves the set vehicle speed for the first precondition by exerting his/her own physical ability without relying solely on an acceleration produced by a motor driving force. The set vehicle speed is set to a speed within a range that can be achieved by the physical ability of the rider. Thus, unlike an electric vehicle that can be accelerated by a grip acceleration operation alone, for example, the human driven vehicle of this arrangement permits automatic traveling by a driving force from the motor alone within a range of speeds appropriate to the physical ability of the rider.

A human driven vehicle according to an example embodiment of the present invention includes a plurality of wheels, a motor to supply at least one of the plurality of wheels with a driving force, a pedal to receive application of a pedal force applied by a rider to drive at least one of the plurality of wheels, a torque sensor to detect the pedal force on the pedal, and a drive controller configured or programmed to control driving of the motor. The drive controller is configured or programmed to perform an automatic control using the driving force from the motor alone when at least a first precondition is met in which the pedal force detected by the torque sensor has reached a set condition.

In the arrangement above, when the pedal force applied by the rider has reached a set level, the drive controller controls the vehicle speed using the motor alone. Thus, until the pedal force reaches a set level, acceleration is effected mainly by pedaling without relying solely on the driving-force of the motor, and, after the set level of pedal force has been reached, the automatic control of vehicle speed is possible without relying on the pedal force. This efficiently reduces the burden of producing a pedal force on the rider during traveling. For example, when the rider puts effort into pedaling and thus the pedal force reaches a set level, the automatic control is possible that maintains the vehicle speed at this time or reduces or prevents a speed decrease. In some implementations, the first precondition may be that, while the rider is riding the human driven vehicle and traveling, the vehicle speed detected by the vehicle speed sensor has reached a set speed by acceleration being not only due to a driving force from the motor, or the pedal force detected by the torque sensor has reached a set condition. In other implementations, the first precondition may be that, while the rider is riding the human driven vehicle and traveling, the vehicle speed detected by the vehicle speed sensor has reached a set speed by acceleration being not only due to a driving force from the motor, and the pedal force detected by the torque sensor has reached a set condition.

Controlling the vehicle speed using the driving force from the motor alone may include controlling the vehicle speed by acceleration being only due to a driving force from the motor. Implementations where vehicle speed is controlled by a driving force from the motor alone include, for example, implementations where vehicle speed is controlled by a driving force from the motor while no pedal force is being input. For example, during the automatic control, the drive controller may control the vehicle speed using a driving force from the motor while no rotation or torque of the pedal is detected. Specifically, the automatic control may be performed if the first precondition is met and no rotation or torque of the pedal is detected. By way of example, after the first precondition has been met, the automatic control may be initiated at the point in time when the rotation or torque of the pedal stops.

Explanation will be provided about the first precondition being that “while the rider is riding the human driven vehicle and traveling, the vehicle speed detected by the vehicle speed sensor has reached a set speed by acceleration being not only due to a driving force from the motor”. In such an implementation, to determine whether the first precondition is met, the drive controller does not necessarily need to detect that the rider is riding the vehicle and traveling, or detect acceleration due to a driving force from the motor alone. The drive controller is able to make a determination regarding the first precondition by settings or controls, e.g., based on the vehicle speed detected by the vehicle speed sensor alone. For example, until the set vehicle speed is reached, the drive controller may control the driving force of the motor to assist the rider only when a pedal force is being input. Thus, the vehicle is not accelerated using the driving force generated by the motor alone until the set vehicle speed is reached. In this case, after the set vehicle speed has been reached, the drive controller may perform a control of the vehicle speed by the motor alone. As a result, when the vehicle speed has reached the set vehicle speed, the controller is able to determine that the set vehicle speed has been reached by acceleration being not only due to the driving force of the motor. For example, if the set vehicle speed is set to a vehicle speed within a range that cannot be achieved without the rider riding the vehicle and traveling (e.g., not lower than about 10 km/h), the controller is able to determine that the set vehicle speed has been reached while the rider is riding the vehicle and traveling if the vehicle speed has reached the set vehicle speed.

Starting from the arrangements above, the first precondition may be that the vehicle speed has reached the set speed at least due to the pedal force applied by the rider. Thus, when the set vehicle speed has been reached at least due to pedaling by the rider, an automatic control of the vehicle speed without relying on pedaling can be performed. Implementations where the vehicle speed reaches the set vehicle speed at least due to the pedal force applied by the rider include implementations where the set vehicle speed is reached due to the pedal force applied by the rider alone and implementations where the set vehicle speed is reached due to the pedal force applied by the rider plus the driving force generated by the motor.

Starting from any one of the arrangements above, the automatic control may be a control to maintain the vehicle speed constant using the driving force from the motor or a control of a rate of decrease in the vehicle speed using the driving force from the motor. Thus, after the set vehicle speed or the set level of pedal force has been reached, the vehicle speed can be maintained constant or a speed decrease can be reduced or prevented using the driving force from the motor alone. A control of the rate of decrease in vehicle speed using the driving force generated by the motor may be, for example, a control to reduce the rate of speed decrease without increasing the vehicle speed using the driving force generated by the motor. This control allows the vehicle speed to gradually decrease while the vehicle is being assisted by the driving force generated by the motor. This control will be hereinafter sometimes referred to as a gradual decrease control. The gradual decrease control slows down a decrease in the vehicle speed by the driving force generated by the motor. It will be understood that, for example, the drive controller may not perform an acceleration (i.e., speed increase) using the driving force from the motor alone during the automatic control.

For example, the drive controller may be configured or programmed to choose which to perform a control that maintains vehicle speed constant or a control of the rate of decrease in vehicle speed based on a selection operation by the rider. Further, for example, the drive controller may be programmed or configured to control the rate of decrease in vehicle speed based on a rider's designation operation to designate a rate of decrease in vehicle speed.

Starting from any one of arrangements above, the drive controller may perform the automatic control if the first precondition is met and the rider has performed an operation to command the automatic control. This allows the rider to perform an operation to indicate whether automatic control is to be performed or not.

Starting from any one of arrangements above, the drive controller may perform the automatic control if the first precondition is met and pedaling by the rider on the pedal has stopped. This enables the automatic control in a situation where the first precondition is met and the rider is not pedaling.

Starting from any one of arrangements above, the drive controller may disable the automatic control if a precondition of disablement is met during the automatic control. The precondition of disablement may include at least one of: detection of braking; detection of a pedal force on, or rotation of, the pedal; an operation by the rider on a disablement operation element; the vehicle speed reaching a set upper limit; the vehicle speed reaching a set lower limit; detection of a disturbance; detection of a vehicle speed increase; passage of a set duration time; or detection of traveling in a curve. This makes it possible to disable automatic control at an appropriate time depending on the circumstances.

Starting from any one of arrangements above, during the automatic control, the drive controller may perform a control of the vehicle speed with respect to a reference vehicle speed, the reference vehicle speed being a vehicle speed when the first precondition is met and then pedaling by the rider on the pedal stops. This enables the automatic control of the vehicle speed with respect to the vehicle speed reached by the pedaling by the rider. This enables automatic control of the vehicle speed depending on the pedaling by the rider. Further, the reference vehicle speed is set to a vehicle speed within a range that can be achieved by pedaling by the rider. The vehicle speed when the pedaling by the rider stops, which defines the reference vehicle speed, is not limited to the vehicle speed exactly when the pedaling stops. For example, the reference vehicle speed may be a vehicle speed detected in response to detection of the pedaling having stopped.

The automatic control may be, for example, a control to maintain the vehicle speed at the reference vehicle speed or a control of the rate of decrease from the reference vehicle speed. Thus, during the automatic control, the motor may be controlled such that the vehicle speed does not exceed the reference vehicle speed due to the motor driving force.

The detection of the pedaling having been stopped by the rider may be performed by, for example, detecting at least one of the input of the pedal force to the pedal having stopped or the rotation of the pedal having stopped.

Example embodiments of the present invention also include a drive control apparatus including the drive controller of any one of arrangements above. Example embodiments of the present invention also include an automatic control method performed by the drive controller.

Now, a human driven vehicle according to an example embodiment of the present invention will be described with reference to the drawings. In the drawings, the same or corresponding elements are labeled with the same reference numerals, and their description will not be repeated. Further, the sizes of the components in the drawings do not exactly represent the sizes of the actual components, the size ratios between the components, or the like. In the description provided below, the directions “front/forward” and “rear (ward)”, “left” and “right”, and “top/up (ward)” and “bottom/down (ward)” of the vehicle refer to such directions as perceived by a rider sitting on the saddle (i.e., seat 24) and gripping the handlebars. The directions “front/forward” and “rear (ward)”, “left” and “right”, and “top/up (ward)” and “bottom/down (ward)” of the vehicle are the same as the respective directions of the vehicle body, i.e., the vehicle body frame of the vehicle. Furthermore, the forward direction of the vehicle is aligned with the front rear direction of the vehicle. The example embodiments described below are merely exemplary, and the present invention is not limited to the example embodiments described below.

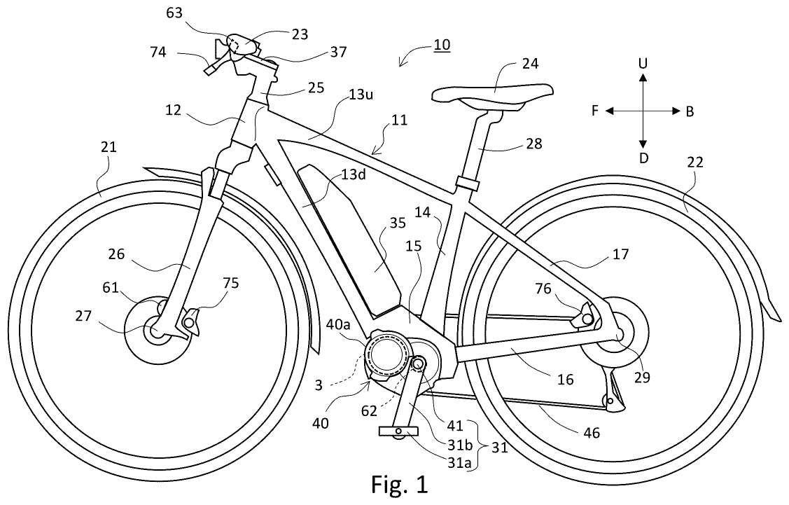

FIG. 1 is a left side view of a human driven vehicle 10 (hereinafter simply referred to as “vehicle 10”) according to the present example embodiment. The characters F, B, U, and D in FIG. 1 indicate forward, rearward, upward, and downward, respectively. By way of example, the vehicle 10 is an electric motor assisted bicycle. The vehicle 10 includes a plurality of wheels 21 and 22, a vehicle body frame 11, a motor 3, and pedals 31. The wheels 21 and 22 and the pedals 31 are rotatably supported on the vehicle body frame 11. The vehicle 10 further includes a transmission mechanism that transmits rotation of the motor 3 to at least one of the wheels 21 and 22 and a transmission mechanism that transmits a pedal force applied to the pedals 31 to at least one of the wheels 21 and 22. At least one of the wheels 21 and 22 is driven by at least one of the pedal force applied to the pedals 31 or the driving force generated by the motor 3.

As shown in FIG. 1, the vehicle 10 includes the vehicle body frame 11. The vehicle body frame 11 extends in the front rear direction. The vehicle body frame 11 includes a head pipe 12, an upper frame portion 13u, a down frame portion 13d, a seat frame portion 14, a pair of chain stays 16, and a pair of seat stays 17. The head pipe 12 is located toward the front with respect to the vehicle 10. The front ends of the down and upper frame portions 13d and 13u are connected to the head pipe 12. The down and upper frame portions 13d and 13u extend in the front rear direction. The down and upper frame portions 13d and 13u extend obliquely downward. The upper frame portion 13u is located higher than the down frame portion 13d. The rear end of the upper frame portion 13u is connected to the seat frame portion 14. The rear end of the down frame portion 13d is connected to a bracket 15. The lower end of the seat frame portion 14 is connected to the bracket 15. The seat frame portion 14 extends upward and obliquely rearward from the bracket 15. It will be understood that the vehicle body frame 11 may not include an upper frame portion 13u.

A handle stem (i.e., steering column) 25 is inserted into the head pipe 12 so as to be rotatable. The handlebars 23 are fixed to the upper end of the handle stem 25. A front fork 26 is fixed to the lower end of the handle stem 25. A front wheel 21 is rotatably supported on the lower end of the front fork 26 by an axle 27.

A grip is attached to each of the left and right ends of the handlebars 23. A left brake lever 74 is attached to a location on the handlebars 23 toward the left, whereas a right brake lever 74 is attached to a location on the handlebars 23 toward the right. The left brake lever 74 enables operating a brake 76 for the rear wheel 22. The right brake lever 74 enables operating a brake 75 for the front wheel 21.

A seat pipe 28 is inserted into the cylindrical seat frame portion 14. A seat 24 is provided on the upper end of the seat pipe 28. Thus, the vehicle body frame 11 rotatably supports the handle stem 25 at its front, and rotatably supports the rear wheel 22 at its rear. Further, the seat 24 and a drive unit 40 are attached to the vehicle body frame 11.

The pair of chain stays 16 are connected to the rear end of the bracket 15. The chain stays 16 are positioned to sandwich the rear wheel 22 from the left and right. One end of each of the seat stays 17 is connected to the rear end of the associated one of the chain stays 16. The seat stays 17 are positioned to sandwich the rear wheel 22 from the left and right. The other end of each of the seat stays 17 is connected to a location on the seat frame portion 14 toward its top. The rear wheel 22 is rotatably supported on the rear ends of the chain stays 16 by an axle 29.

A vehicle speed sensor (i.e., speed sensor) 61 that detects rotation of the front wheel 21 is provided on the front fork 26. The vehicle speed sensor 61 includes, for example, a detected element that rotates together with the front wheel 21 (i.e., a wheel), and a detecting element fixed to the vehicle body frame 11 to detect rotation of the detected element. The detecting element detects the detected element in a mechanical, magnetic, or optical manner. The vehicle speed sensor 61 may detect rotation of a rotating body other than the front wheel 21 that rotates as the vehicle 10 moves forward, such as the rear wheel 22, motor 3, crankshaft 41, transmission gear, or chain.

The vehicle 10 includes a brake sensor 63. The brake sensor 63 detects a braking operation by the rider, i.e., an operation of the brakes 75 and 76. The brake sensor 63 converts the movement of the brakes being operated by the rider into electrical signals. The brake sensor 63 may be, for example, a mechanical or electrical switch that detects the movement of the brake levers or a pressure sensor that detects brake pressure. The brake sensor 63 is attached to the handlebars 23 or vehicle body frame 11, for example.

The drive unit 40 is attached to the lower edge of the bracket 15 by fasteners (not shown). The drive unit 40 includes a housing 40a defining the exterior of the drive unit 40. A motor 3 is contained in the housing 40a. A crankshaft 41 extends through the housing 40a in the left right direction. The crankshaft 41 is rotatably supported on the housing 40a by a plurality of bearings.

A torque sensor 62 is provided around the crankshaft 41 to detect a pedal force applied by the rider. The torque sensor 62 detects torque that rotates the crankshaft 41 about its axis. The torque sensor 62 may be, for example, a non-contact torque sensor such as a magnetostrictive sensor, or a contact torque sensor such as an elastic body variable detection type sensor. A magnetostrictive torque sensor includes a magnetostrictive member that produces magnetostrictive effects and that receives a rotational force of the crankshaft, and a detection coil that detects a change in magnetic permeability caused by a force from the magnetostrictive member.

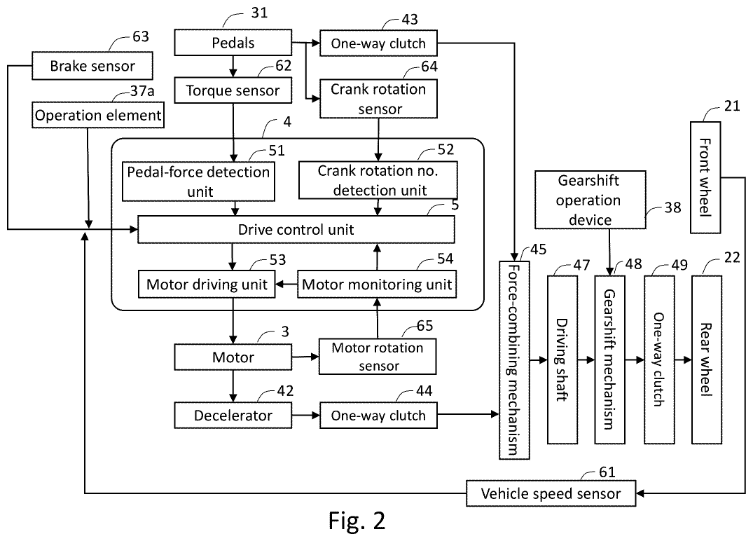

Crank arms 31b are attached to the respective ends of the crankshaft 41. Pedal steps 31a are attached to the distal ends of the respective crank arms 31b. The pedals 31 are composed of the crankshaft 41, crank arms 31b and pedal steps 31a. The crankshaft 41 is rotated by the rider pressing the pedals 31. Although not shown, the vehicle 10 is provided with a driving sprocket that rotates together with the crankshaft 41 and a driven sprocket that rotates together with the rear wheel 22. A chain 46 is wound around the driving and driven sprockets to connect them. It will be understood that the chain 46 may be replaced by a belt, a shaft or the like. A one-way clutch 49 (see FIG. 2) is provided in the path of transmission of rotation from the driven sprocket to the rear wheel 22. The one-way clutch 49 transmits forward rotation (i.e., normal rotation), and does not transmit rearward rotation (i.e., reverse rotation).

A transmission mechanism (not shown) is provided within the drive unit 40 to transmit the rotation of the motor 3 to the driving sprocket (or chain 46). The transmission mechanism includes, for example, a decelerator (i.e., a set of reduction gears) 42 (see FIG. 2). The decelerator 42 reduces the rotational speed of the motor before transmission to the driving sprocket. Further, the transmission mechanism includes a synthesizing mechanism that synthesizes the rotation of the crankshaft 41 and the rotation of the motor 3 before transmission to the driving sprocket. The synthesizing mechanism includes a cylindrical member, for example. The crankshaft 41 is located within the cylindrical member. The driving sprocket is attached to the synthesizing mechanism. The synthesizing mechanism rotates about the same axis of rotation as the crankshaft 41 and driving sprocket. One-way clutches 43 and 44 (see FIG. 2) may be provided in the path of transmission of rotation from the crankshaft 41 to the synthesizing mechanism and the path of transmission of rotation from the motor 3 to the synthesizing mechanism, respectively. The rotational force transmitted from the motor 3 to the driving sprocket via the transmission mechanism provides the driving force for the wheel (i.e., rear wheel 22).

A battery unit 35 is positioned on the down frame portion 13d. The battery unit 35 supplies the motor 3 of the drive unit 40 with electric power. The battery unit 35 includes a battery and a battery control unit, not shown. The battery is a chargeable battery that can be charged and discharged. The battery control unit controls the charging and discharging of the battery and, at the same time, monitors output current, remaining capacity, and other information about the battery. It will be understood that the battery unit 35 may be positioned on the seat frame portion 14 or upper frame portion 13u.

The handlebars 23 are provided with an operation element 37 that receives various operations by the rider. The operation element 37 includes, for example, an input unit that receives user operations, such as a set of buttons or a touch screen. The operation element 37 may also include a display. In such implementations, the input unit of the display device may serve as the operation element 37. The display shows various information relating to the vehicle 10.

FIG. 2 is a block diagram illustrating an exemplary mechanical and electrical connection configuration of the components of the vehicle 10 shown in FIG. 1. In the implementation shown in FIG. 2, rotation of the pedals 31 (including the pedal steps 31a, crank arms 31b, and crankshaft 41) is transmitted to a force combining mechanism 45 via the one-way clutch 43. Rotation of the motor 3 is transmitted to the force combining mechanism 45 via the decelerator 42 and the one-way clutch 43. The force combining mechanism 45 includes, for example, the above-mentioned synthesizing mechanism, driving sprocket, chain 46, and driven sprocket. Within the force combining mechanism 45, a driving force is transmitted through the synthesizing mechanism, driving sprocket, chain 46, and driven sprocket in this order. Rotation of the driven sprocket is transmitted to the rear wheel 22 via a driving shaft 47, a gearshift mechanism 48, and the one-way clutch 49.

The gearshift mechanism 48 changes the gear ratio in response to an operation of a gearshift operation device 38 by the rider. The gearshift operation device 38 may be mounted on the handlebars 23 (FIG. 1), for example. In this implementation, the gearshift mechanism 48 is an internal gearshift located between the driving shaft 47 and rear wheel 22; alternatively, the gearshift mechanism 48 may be an external gearshift. If the gearshift mechanism 48 is an external gearshift, the driven sprocket may include a multi-gear sprocket. In such implementations, the multi-gear sprocket, around which the chain 46 is wound, enables switching in response to a rider operation of the gearshift operation device 38. The one-way clutch 49 transmits the rotation of the gearshift mechanism 48 to the rear wheel 22 only when the rotational speed of the output shaft of the gearshift mechanism 48 is higher than the rotational speed of the rear wheel 22. When the rotational speed of the output shaft of the gearshift mechanism 48 is lower than the rotational speed of the rear wheel 22, the one-way clutch 49 does not transmit the rotation of the gearshift mechanism 48 to the rear wheel 22. It will be understood that the gearshift mechanism 48 and gearshift operation device 38 may be omitted.

The pedal force generated by the rider pressing the pedals 31 rotates the driving sprocket in the forward direction, and is transmitted, via the chain 46, as a driving force that rotates the rear wheel 22 in the forward direction. Further, the rotational force generated by operation of the motor 3 rotates the crankshaft 41 in the forward direction. Thus, the rotational force output by the motor 3 is transmitted as a driving force that rotates the rear wheel 22 in the forward direction. Further, if the pedal force applied by the rider and the rotational force output by the motor 3 are transmitted to the crankshaft simultaneously, the rotational force output by the motor 3 is added, as assistance, to the pedal force applied by the rider.

The vehicle 10 includes a controller 4 that controls the motor 3. For example, an electronic device mounted on a circuit board within the housing 40a of the drive unit 40 may correspond to the controller 4. The electronic device includes, for example, a processor or an electronic circuit. The controller 4 is electrically connected to, at least, the vehicle speed sensor 61, torque sensor 62, brake sensor 63, and motor 3. In the implementation shown in FIG. 2, the controller 4 is connected to a crank rotation sensor 64 and a motor rotation sensor 65. These connections may use cables, or may be wireless.

The crank rotation sensor 64 detects rotation of the crankshaft 41. The crank rotation sensor 64 may include, for example, a detected element that rotates together with the crankshaft 41, and a detecting element fixed to the vehicle body frame 11 to detect rotation of the detected element. The detecting element is able to detect the detected element in a mechanical, optical, or magnetic manner.

The motor rotation sensor 65 detects rotation of the motor 3. The motor rotation sensor 65 may detect rotation of the rotor of the motor 3, or may detect rotation based on electric current, voltage or other electrical signals relating to the motor 3.

The transmission of the driving force generated by the motor 3 is not limited to the above-described mechanism. For example, the drive unit 40 may include an output shaft that extends outwardly from within the housing 40a in the left right direction. In such implementations, the rotation of the motor 3 is transmitted to the output shaft via the transmission mechanism. Outside the housing 40a, an auxiliary sprocket is attached to the output shaft. The chain 46 is wound around the auxiliary sprocket. The rotational force generated by operation of the motor 3 rotates the auxiliary sprocket and, via the chain 46, rotates the rear wheel 22 in the forward direction.

In the implementation of FIG. 1, the motor 3 is contained in the drive unit 40 attached to the vehicle body frame 11. Alternatively, the motor may be positioned on the hub of a wheel (at least one of the front or rear wheel 21 or 22) of the vehicle 10. In such implementations, the motor may be an in-wheel motor incorporated in the hub (i.e., hub motor). The hub motor may include, for example, a rotor and a stator. The axis of rotation of the rotor may be the same as the axis of the wheel 27. The hub may be provided with a gear that transmits the rotation of the hub motor to the wheel (i.e., front wheel 21). The gear may be a planetary gear, for example. Further, a one-way clutch may be provided in the path of transmission of rotation between the hub motor and wheel (i.e., front wheel 21).

In the implementation of FIG. 2, the controller 4 includes a drive controller 5. By way of example, the controller 4 may be a motor control unit (MCU). The controller 4 may include a processor and memory, for example. The processor may execute a program in the memory to implement the functions of the drive controller 5. Al least some of the functions of the drive controller 5 may be implemented by a circuit other than the processor. In addition to the drive controller 5, the controller 4 includes a pedal force detection unit 51, a crank rotation number detection unit 52, a motor driving unit 53, and a motor monitoring unit 54. These functional units may be defined by the processor or other circuits.

The pedal force detection unit 51 detects a pedal force (i.e., torque) by acquiring, from the torque sensor 62, a signal corresponding to the torque detected by the sensor. The pedal force detection unit 51 may acquire a voltage signal or an electric current signal from the torque sensor 62 and convert such a signal to a torque value, or acquire a torque value from the torque sensor 62.

The crank rotation number detection unit 52 acquires, from the crank rotation sensor 64, a signal corresponding to the rotation of the crankshaft 41 to detect the number of crank rotations. The crank rotation number detection unit 52 may acquire a voltage signal or an electric current signal (e.g., pulse signal) from the crank rotation sensor 64 and convert such a signal to a number of rotations, or acquire a value of the number of rotations.

The vehicle speed sensor 61 detects a rotational angle of the front wheel 21 (or another rotating body) and provides, as an output, a signal corresponding to the rotational angle to the controller 4. For example, the vehicle speed sensor 61 detects rotation of the front wheel 21 at intervals of a predetermined angle and outputs a rectangular wave signal or a sine wave signal. The processor of the drive controller 5 calculates the vehicle speed by calculating the rotational speed of the front wheel 21 from the output signal of the vehicle speed sensor 61. In some implementations, the calculation of the rotational speed or vehicle speed may be performed by the vehicle speed sensor 61.

The motor monitoring unit 54 acquires, from the motor rotation sensor 65, a signal indicating the rotation of the motor such as the number of rotations or rotational speed of the motor. In addition to or in lieu of the number of motor rotations or rotational speed, the motor monitoring unit 54 may acquire a value relating to the drive of the motor 3, such as the electric current or voltage in the motor 3.

To implement the functions of the drive controller 5, the processor provides, as an output, a control signal (e.g., motor command value) for the motor 3. The motor 3 is driven by the motor driving unit 53 operating in accordance with the control signal. The motor driving unit 53 may be an inverter, for example, and supplies the motor 3 with an amount of electric power from the battery unit 35, the amount corresponding to the control signal from the processor. The motor 3 supplied with electric power rotates to generate a driving force indicated by the drive controller 5.

If at least a predetermined first precondition is met, the drive controller 5 performs an automatic control to control the vehicle speed using the driving force generated by the motor 3 alone. A first example of the first precondition may be that, while the rider is riding the vehicle 10 and traveling, the vehicle speed has reached a set speed by acceleration being not only due to the driving force generated by the motor 3. A second example of the first precondition may be that the pedal force detected by the torque sensor 62 has reached a set condition.

For both the first and second examples, until the first precondition is met, the drive controller 5 performs a normal assist control that, when a pedal force is being applied, causes the motor 3 to generate a driving force depending on the pedal force. In other words, until the first precondition is met, the drive controller 5 prevents the motor 3 from generating a driving force when no pedal force is being applied. Thus, as the motor 3 is driven only when a human power (i.e., pedal force) is being input until the first precondition is met, the drive unit is controlled so as not to perform an acceleration that is only due to a driving force generated by the motor 3 until then. In such implementations, if the vehicle speed has reached the set vehicle speed or the torque has reached the set condition, the drive controller 5 is able to determine that acceleration that is only due to a driving force generated by the motor 3 has not been performed.

Further, for example, the set vehicle speed for the first precondition may be set to a vehicle speed within a range that cannot be achieved if the rider is not riding the vehicle and traveling (for example, a range of speeds that cannot be achieved by walking and pushing (by way of example, not lower than about 10 km/h). In such implementations, if the vehicle speed has reached the set vehicle speed, the drive controller 5 is able to determine that the set vehicle speed has been reached while the rider is riding the vehicle and traveling. In other words, the unit is able to determine in a simple manner that the set vehicle speed has been reached while the rider is riding the vehicle.

During the automatic control after the first precondition has been met, the drive controller 5 causes the motor 3 to generate a driving force even when no pedal force is being applied, thus maintaining the vehicle speed constant or controlling the rate of speed decrease. During the automatic control, for example, the vehicle speed is controlled by a motor driving force that is within a range that does not increase the vehicle speed while no pedal force is being applied.

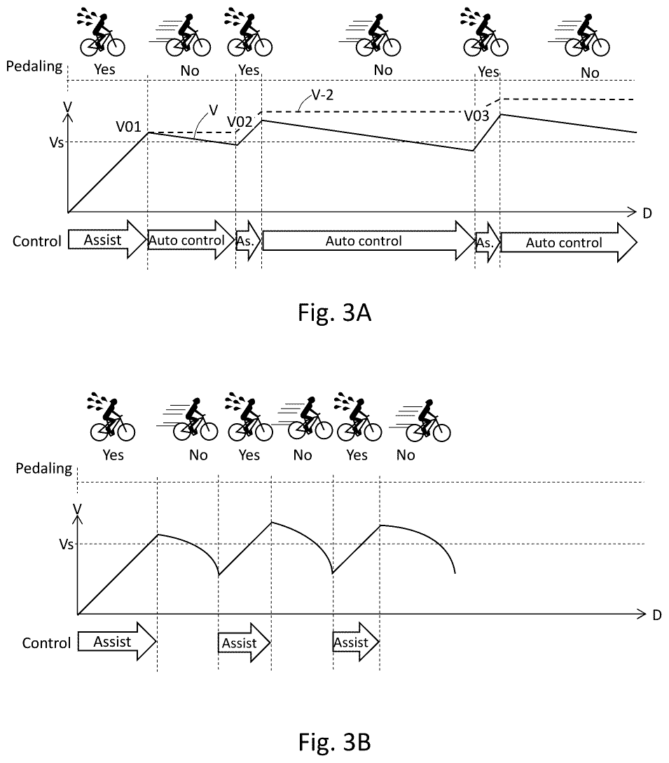

FIG. 3A illustrates an exemplary implementation with a normal assist control and an automatic control by the drive controller 5. In the graph of FIG. 3A, the vertical axis indicates the vehicle speed V, whereas the horizontal axis indicates the travel distance D. In the implementation of FIG. 3A, beginning with the vehicle speed V of zero, while the rider is pedaling to increase the vehicle speed until the set vehicle speed Vs is reached, the drive controller 5 performs a normal assist control to cause the motor 3 to output a driving force depending on the pedal force. After the vehicle speed has exceeded the set vehicle speed Vs and when the rider stops pedaling, automatic control of the vehicle speed is initiated with respect to the vehicle speed V01 at this time. In FIG. 3A, line V indicates an implementation of the automatic control in a gradual decrease mode, whereas broken line V-2 indicates an implementation of an automatic control in a speed maintaining mode (i.e., constant speed mode). For the automatic control in the gradual decrease mode, the vehicle speed is controlled by the driving force generated by the motor 3 so as to slow down a decrease in the vehicle speed during a no-pedaling period. For the automatic control in the constant speed mode, the vehicle speed is controlled by the driving force generated by the motor 3 so as to maintain the vehicle speed constant during a no-pedaling period. Thus, the no-pedaling travel distance after pedaling has stopped is significantly increased over cases where there is no driving force generated by the motor 3. When the rider resumes pedaling during automatic control, the drive controller 5 disables automatic control and transitions to the normal assist control depending on the pedal force. Then, when the vehicle speed has exceeded the set vehicle speed Vs due to the pedal force applied by the rider plus the driving force generated by the motor 3 and the rider then stops pedaling, automatic control of the vehicle speed is initiated with respect to the vehicle speed V02 (>Vs) at this time. Thereafter, similarly, disablement of automatic control, transition to normal assist control and, when pedaling has stopped, automatic control with respect to the vehicle speed V03 (>Vs) are performed.

In the implementation of FIG. 3A, during a period of automatic control, the vehicle speed of the vehicle 10 is gradually decreased or maintained constant while the vehicle is receiving a driving force generated by the motor 3. This significantly increases the inertial travel distance after the rider has put effort into pedaling and thus reached the set vehicle speed and then stops pedaling. This gives the rider an exhilaration from a prolonged travel of the vehicle 10 after pedaling. Furthermore, after the set vehicle speed has been reached, the rider is able to maintain traveling within a vehicle speed range near the set speed with a smaller pedal force. This reduces the fatigue of the rider while maintaining certain vehicle speeds, especially during long distance travel. This improves comfort and convenience. On the other hand, if the normal assist control is performed but no automatic control, as shown in FIG. 3B, the frequency and strength of pedaling needed to maintain certain vehicle speeds are significantly larger than in the scenario of FIG. 3A. Furthermore, in the scenario of FIG. 3A, the amount of variations of the vehicle speed is smaller than in the scenario of FIG. 3B. Thus, a combination of the normal assist control and the automatic control enables maintaining the vehicle speed near the set vehicle speed while reducing the amount of variations of the vehicle speed. This enables efficient travel assistance by the driving force generated by the motor 3.

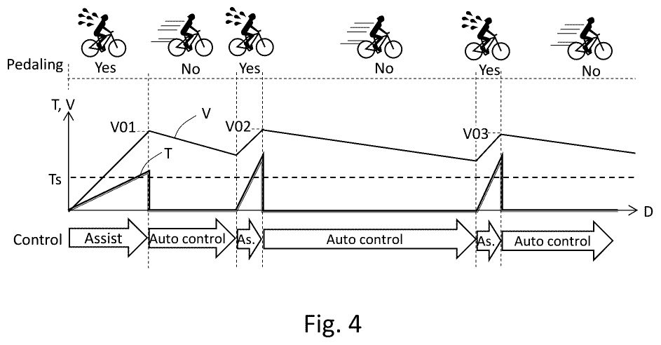

FIG. 4 illustrates another exemplary implementation with a normal assist control and an automatic control by the drive controller 5. In the graph of FIG. 4, the vertical axis indicates the vehicle speed V and the pedal force (i.e., torque) T, whereas the horizontal axis indicates the travel distance D. In the implementation of FIG. 4, beginning with the vehicle speed V of zero, the rider pedals to increase the pedal force and vehicle speed until the pedal force reaches a set level (by way of example, set pedal force Ts) and, thereafter, when the rider stops pedaling, automatic control of the vehicle speed initiates with respect to the vehicle speed V01 at this time. During the automatic control, the vehicle speed is controlled by the driving force generated by the motor 3 so as to slow down a decrease in the vehicle speed during a no-pedaling period. When the rider resumes pedaling during the automatic control, the drive controller 5 disables the automatic control and transitions to the normal assist control depending on the pedal force. Then, again, when the pedal force T applied by the rider (by way of example, the peak or average value of pedal force per pedaling cycle) is above the set level (Ts) and the rider stops pedaling, the automatic control of vehicle speed is initiated with respect to the vehicle speed at this time, V02 (>Vs). Thereafter, similarly, disablement of the automatic control, transition to the normal assist control and, when pedaling has stopped, automatic control with respect to the vehicle speed V03 (>Vs) are performed.

In the implementation of FIG. 4, during a period of automatic control, the vehicle speed of the vehicle 10 gradually decreases while the vehicle is receiving a driving force generated by the motor 3. This significantly increases the inertial travel distance after the rider has put effort into pedaling and thus the pedal force has reached the set level and then pedaling stops. This gives the rider an exhilaration from a prolonged travel of the vehicle 10 after pedaling. Furthermore, the rider may repeat pedaling to increase the pedal force to a set level by concentrating for short periods of time to maintain traveling at relatively high vehicle speeds. This reduces the fatigue of the rider while maintaining certain vehicle speed, especially during long distance travel. This improves comfort and convenience. Moreover, if the first precondition involves the pedal force as in FIG. 4, the automatic control may be initiated in response to an effort by the rider in situations that require a certain amount of pedal force, such as traveling on an upward slope, for example. It will be understood that the set level of pedal force is not limited to the set pedal force Ts, as in the implementation of FIG. 4, and may be a predetermined pedal force rate (i.e., rate of change of pedal force), for example.

In the implementations of FIGS. 3A and 4, automatic control of the vehicle speed is performed with respect to a reference vehicle speed represented by the vehicle speed at the time when pedaling stops after the first precondition has been met. Thus, the vehicle speed that serves as a reference for automatic control varies depending on the pedaling up until the initiation of the automatic control. For example, the rider may, after reaching the set vehicle speed, increase the vehicle speed through pedaling and then stop pedaling. The larger the increase in vehicle speed, the longer the travel distance resulting from the automatic control after pedaling has been stopped. The rider is able to adjust the travel distance with the automatic control by adjusting the amount of a speed increase through pedaling. Whether pedaling has stopped can be determined by, for example, detecting at least one of a stop of input of a pedal force to the pedals based on a signal from the torque sensor 62, or a stop of rotation of the crankshaft 41 (i.e., pedals 31) based on a signal from the crank rotation sensor 64.

In the implementations of FIGS. 3A and 4, detection of pedaling by the rider represents the precondition to disable the automatic control. Thus, the automatic control is a control of the vehicle speed using a driving force generated by the motor 3 without relying on pedaling. Further, a transition from the automatic control to a normal assist control upon resumption of pedaling, as in the implementations above, gives the rider a motivation to resume pedaling when wishing to increase the vehicle speed. Such a motivation is a feature and a value common to bicycles (i.e., vehicles that use a pedal force as a driving force). The rider, while experiencing the feeling of driving a bicycle, can also experience a feeling specific to automatic control, such as higher comfort, exhilaration and the ease of long distance traveling.

In the implementation of FIG. 3A, in addition to the first precondition, i.e., the vehicle speed reaching the set vehicle speed Vs, a stop of pedaling represents an additional precondition to initiate the automatic control. In the implementation of FIG. 4, in addition to the first precondition, i.e., the set level of pedal force being reached, a stop of pedaling represents an additional precondition to initiate the automatic control. The preconditions to initiate the automatic control in addition to the first precondition are not limited to these implementations. For example, a stop of pedaling may not be a precondition, and automatic control may be initiated when the vehicle speed has reached the set vehicle speed Vs or when the pedal force has reached the set level. In other implementations, at least one of the preconditions described below may be an additional precondition to initiate the automatic control in addition to the first precondition.

In addition to the first precondition, a rider operation of the operation element to command automatic control may represent an additional precondition to initiate the automatic control. For example, the drive controller 5 may initiate the automatic control if the first precondition is met and the rider has performed an operation to command automatic control. The operation to command automatic control may be, for example, an operation of the operation element 37 (e.g., a button, a lever, a switch). For example, the drive controller 5 may initiate automatic control when the first precondition is met and the rider has performed a command operation on the operation element 37 a predetermined number of times. In such implementations, automatic control may be performed with respect to the vehicle speed at the time of the operation to command automatic control. In one exemplary implementation, when the vehicle speed is not lower than the set vehicle speed (V≥Vs) and the rider depresses the automatic control button once, automatic control may be initiated with respect to the vehicle speed at the time of the depression. In an alternative exemplary implementation, when the vehicle speed is not lower than the set vehicle speed (V≥Vs) and the rider depresses the automatic control button once, the vehicle enters an automatic control stand-by state and, when the rider depresses the automatic control button for the second time, automatic control may be initiated with respect to the vehicle speed at this time.

In addition to the first precondition, the rider not operating the brakes, i.e., the brakes being released, may represent an additional precondition to initiate the automatic control. Thus, automatic control is not performed when the rider is operating the brakes. For example, when the brake sensor 63 detects no braking operation, the drive controller 5 is able to determine that the rider is not operating the brakes.

In addition to the first precondition, the vehicle speed being not higher than a set upper limit may represent an additional precondition to initiate the automatic control. Thus, the drive controller 5 does not perform automatic control when the vehicle speed is above the set upper limit. The upper limit of the vehicle speed may be set based on rules, such as laws, for example.

In the implementations of FIGS. 3A and 4, detection of pedaling is a precondition to disable automatic control. The preconditions to disable automatic control are not limited to these implementations. For example, at least one of the conditions described below and detection of pedaling may represent a precondition to disable automatic control. It will be understood that detection of pedaling may be performed by, for example, at least one of detection of a pedal force on the pedals based on a signal from the torque sensor 62 or detection of rotation of the pedals 31 based on a signal from the crank rotation sensor 64.

The drive controller 5 may disable automatic control when a predetermined braking operation by the rider is detected. For example, automatic control may be disabled when a braking operation by the rider is detected. Alternatively, automatic control may be disabled when a braking operation by the rider continues for a predetermined period of time or longer. In such implementations, when the rider performs a braking operation for less than the predetermined period of time, automatic control is continued even after the speed has been decreased by the braking operation. This allows the rider to adjust the vehicle speed during automatic control by operating the brakes for less than the predetermined period of time.

The drive controller 5 may disable automatic control when the rider has performed an operation on the operation element to command disablement of the automatic control. The operation to command disablement of the automatic control may be, for example, a rider operation of the operation element 37 (e.g., a button, a lever or a switch). The operation element 37 that receives an operation to command disablement of automatic control may be the same operation element that receives an operation to command automatic control, or may be another element. For example, automatic control may be disabled when the same operation element 37 that has received a predetermined operation to command initiation of automatic control (e.g., a button being depressed a predetermined number of times) thereafter receives a predetermined operation to command disablement (e.g., the button being depressed a predetermined number of times). Alternatively, the drive controller 5 may continue automatic control while an operation by the rider on the operation element 37 to command automatic control continues (e.g., while the rider is depressing the button), and disable automatic control when the operation to command automatic control is ended (e.g., the rider releases the button).

The drive controller 5 may disable automatic control at the point of time when a set duration time passes after the initiation of automatic control. The duration time may be stored in the memory in the drive controller 5. The duration time may be a fixed value, or may be automatically updated depending on vehicle conditions (e.g., remaining battery capacity). Alternatively, the rider may be able to set a duration time. For example, the duration time may depend on the level of the remaining battery capacity (i.e., battery voltage). For example, the duration time of a single round of automatic control may be 60 seconds if the remaining battery capacity is 100% to 50%, and the duration time may be 30 seconds if the remaining battery capacity is lower than 50%. Alternatively, the duration time may be based on an amount of electric power consumption of the battery. For example, the duration time may be the time until the power consumption of the battery due to automatic control reaches a predetermined amount (e.g., 5% of the total battery capacity).

When an increase in vehicle speed is detected during automatic control, the drive controller 5 may disable automatic control. For example, during automatic control, when pedaling has been stopped and when an increase in vehicle speed is detected, then, automatic control may be disabled. For example, vehicle speed may increase without pedaling when, for example, the vehicle 10 is traveling on a downward slope during automatic control or when the vehicle, having traveled on an upward slope, is now traveling on a level surface during automatic control. In such cases, the drive controller 5 may disable automatic control. Further, when an increase in vehicle speed is detected during automatic control, the drive controller 5 may disable automatic control and, if the duration time of a vehicle speed increase turns out to be within a predetermined period of time, resume automatic control. In such implementations, the drive controller 5 may detect an initiation of a vehicle speed increase and a termination of vehicle speed increase based on signals from the vehicle speed sensor 61, thus determining the duration time of vehicle speed increase.

When it is detected that the vehicle speed has reached a set upper limit during automatic control, the drive controller 5 may disable automatic control. When the vehicle speed has exceeded the set upper limit and if the subsequent speed decrease resulted in a speed below the set upper limit, the drive controller 5 may resume automatic control.

When it is detected that the vehicle speed has reached a set lower limit during automatic control, the drive controller 5 may disable automatic control. The lower limit may be set to the lower limit of the range of speeds covered by automatic control, for example.

The drive controller 5 may disable automatic control when a disturbance is detected. For example, automatic control may be disabled when a disturbance is detected. Alternatively, automatic control may be disabled when detection of a disturbance continues for a predetermined period of time or longer. Thus, for example, automatic control is disabled when the vehicle 10 is traveling on a gravel road or on an off road with projections/indentations or steps. A disturbance may be detected based on, for example, a signal from at least one of the acceleration sensor (e.g., a G sensor, not shown) provided on the vehicle 10, the vehicle speed sensor 61, or the motor monitoring unit 54. By way of example, the detection of a disturbance may be achieved by detecting that the acceleration of the vehicle body frame 11 detected by the acceleration sensor exceeds a threshold. Alternatively, the detection of a disturbance may be achieved by detecting that a change in vehicle speed over time or a change in motor output value over time exceeds a threshold.

The drive controller 5 may disable automatic control when it is detected that the vehicle 10 is traveling along a curve (curve traveling). Curve traveling may be detected based on, for example, at least one of a signal from a vehicle body motion sensor (not shown) included in the vehicle 10 or a signal from a steering angle sensor. The vehicle body motion sensor detects a change in the attitude of the vehicle body frame 11 of the vehicle 10 relative to the road surface. For example, the detection of curve traveling may be detecting, based on a signal from the vehicle body motion sensor, that the vehicle 10 is traveling while the vehicle body frame 11 is tilted by a predetermined angle or greater relative to the upright position. The vehicle body motion sensor may include, for example, an angular velocity sensor about a plurality of axes of the vehicle body frame 11. The information from the vehicle body motion sensor may be, for example, a physical quantity relating to one of the yaw angle, roll angle, or pitch angle of the vehicle body. In addition to, or in lieu of, the attitude of the vehicle along the curve detected by the vehicle body motion sensor, the detection of curve traveling may be achieved by detecting that the steering angle detected by the steering angle sensor is not lower than a threshold.

In the above implementations, if the first precondition is the first example (i.e., set vehicle speed), the drive controller 5 determines whether the first precondition is met based on the vehicle speed detected by the vehicle speed sensor 61. In these implementations, until the vehicle speed reaches a set vehicle speed, the unit performs a control that provides a driving force using the motor 3 only when a pedal force is being applied, and the set vehicle speed is set to a vehicle speed within a range found during traveling, thus enabling determining that the rider is riding the vehicle 10 and traveling and the acceleration is not only due to a driving force generated by the motor 3, without directly detecting these conditions. Alternatively, at least one of these conditions may be directly determined. For example, the drive controller 5 may store, in its memory, history data about an output of the pedal force detected by the torque sensor 62 and the driving force generated by the motor 3 and, based on this history data, determine whether the set vehicle speed has been reached by acceleration of the vehicle being not only due to the driving force generated by the motor. Further, the drive controller 5 may determine whether the rider is riding the vehicle 10 and traveling based on a signal from a pressure sensor (not shown) on the seat. Cases where the set vehicle speed is reached by acceleration of the vehicle being not only due to the driving force generated by the motor include, for example, cases where the set vehicle speed is reached due to the pedal force applied by the rider alone and cases where the set vehicle speed is reached due to the pedal force applied by the rider plus the assistance by the motor 3, as well as cases where the set vehicle speed is reached due to traveling on a downward slope or traveling with a tail wind.

In the implementation of FIG. 3A, the determination as to whether the vehicle speed has reached the set vehicle speed is made based on a comparison between the detected value of vehicle speed at the time of the determination and the set vehicle speed. In a variation, that determination may be made based on a comparison between the average, maximum, or any other representative value of vehicle speed in a period including the time of the determination, on the one hand, and the set vehicle speed, on the other. In the implementation of FIG. 4, the first precondition is that a value indicating the detected amount of pedal force has reached a set level. The pedal force reaching the set level for the first precondition is not limited to this implementation. For example, the first precondition may be that the amount of pedal force or the rate of change in pedal force (e.g., derivative) has reached a set value. Further, the pedal force for the first precondition may be the detected value of pedal force at the time of determination or may be the average or maximum detected value of pedal force in a period including the time of determination, or any other representative value. Since a pedal force pulsates, the peak value of pedal force in each cycle of pulsation, such as one cycle of pedaling, or any other representative value, for example, may be treated as a value of pedal force used in determining whether the pedal force has reached a set value.

The first precondition may be a combination of the precondition relating to vehicle speed in FIG. 3A and the precondition relating to pedal force in FIG. 4. For example, the first precondition may be met if the vehicle speed has reached a set vehicle speed or if the pedal force has reached a set level. Alternatively, the first precondition may be met if the vehicle speed has reached a set vehicle speed and if the pedal force has reached a set level.

In the above implementations, during automatic control, the drive controller 5 controls the rate of decrease in vehicle speed relative to a reference vehicle speed. Specifically, the drive controller 5 performs an automatic control that gradually reduces the vehicle speed from the reference vehicle speed while minimizing the rate of decrease in vehicle speed using the motor driving force (i.e., gradual decrease control). In the implementations of FIGS. 3A and 4, the vehicle speed is controlled to decrease at a constant rate of change (i.e., change over time). The gradual decrease in vehicle speed under control is not limited to a linear decrease; the rate of change in vehicle speed may vary depending on the time, travel distance, or vehicle speed. Further, the control of the vehicle speed using the motor 3 during the automatic control may be a control that gradually decreases the output of the motor 3 (e.g., motor torque) W, or may be a control of the motor 3 that gradually decreases the vehicle speed.

During the automatic control, the drive controller 5 may perform a control to maintain the vehicle speed at the reference vehicle speed. In such implementations, the control of vehicle speed by the motor 3 during automatic control may be a control that maintains a certain output of the motor 3 (e.g., motor torque) W, or may be a control of the motor 3 that maintains a certain vehicle speed.

During automatic control, in addition to using vehicle speed and motor output, the drive controller 5 may control the driving force from the motor 3 using a determination as to whether the vehicle is traveling on an upward slope, a downward slope, or a level road based on a signal from the acceleration sensor, for example.

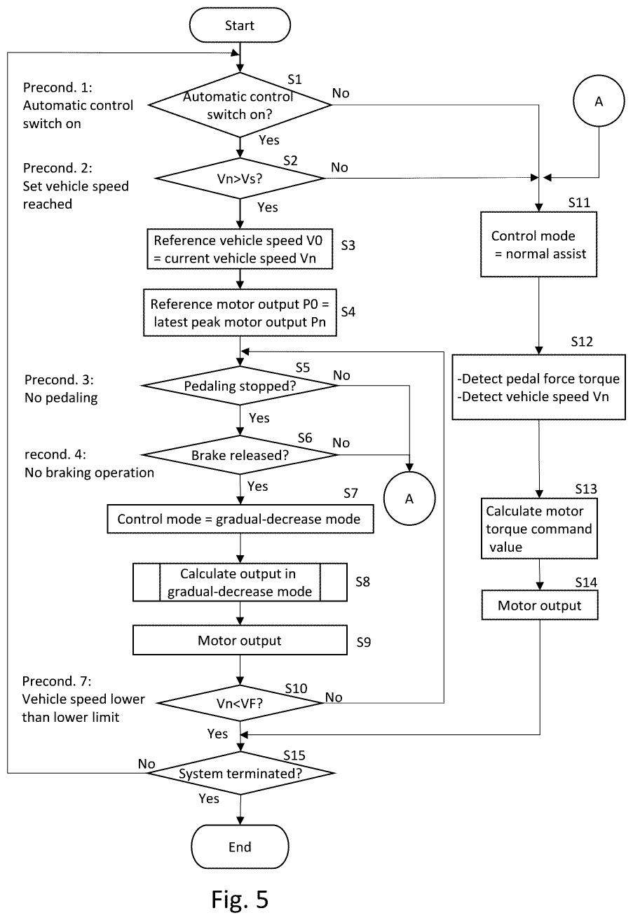

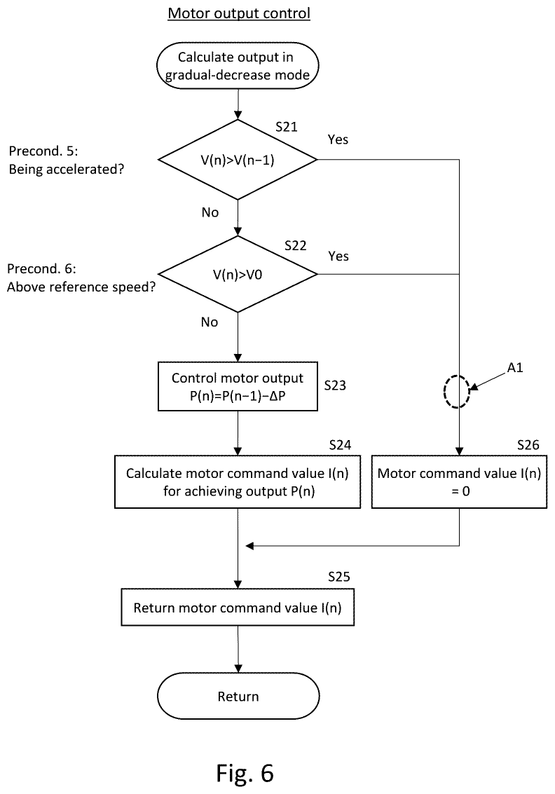

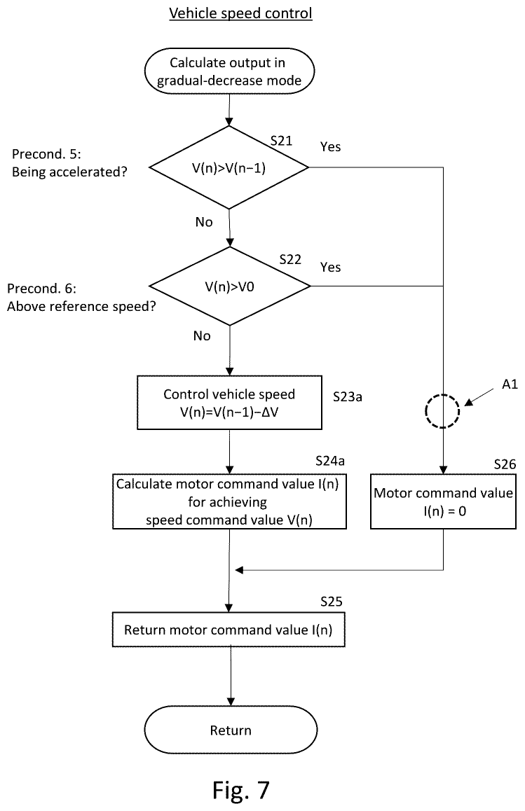

FIG. 5 is a flow chart illustrating an exemplary automatic control process by the drive controller 5. FIG. 6 is a flow chart illustrating an exemplary process of step S8 (i.e., calculation of the output in the gradual decrease mode) in FIG. 5. FIG. 7 is a flow chart illustrating another exemplary process of step S8 (i.e., calculation of the output in the gradual decrease mode) in FIG. 5.

In the implementation shown in FIG. 5, the preconditions to initiate the automatic control are: (Precondition 1) switch-on of automatic control (with a command operation by the rider); (Precondition 2) the current vehicle speed Vn being higher than the set vehicle speed Vs (Vn>Vs); (Precondition 3) pedaling stopped; and (Precondition 4) the brakes released. That is, in the process of FIG. 5, if the automatic control switch is on (“Yes” at step S1) and Vn>Vs (“Yes” at step S2), the reference vehicle speed V0 is set to the current vehicle speed Vn (S3), and the reference motor output P0 is set to the latest peak motor output Pn (S4). The automatic control switch for step S1 may be a switch that switches between the permission and non-permission of automatic control. In the implementation of FIG. 5, the automatic control switch may be a gradual decrease mode switch that switches between the permission and non-permission of gradual mode.

It will be understood that, in implementations where automatic control is performed using a motor output value as a target (i.e., motor output control; see FIG. 6), the reference motor output P0 is used as the initial target value. Accordingly, in implementations where automatic control is performed using a vehicle speed as a target value (i.e., vehicle speed control; see FIG. 7), the process of step S4 is unnecessary. In a variation, the reference motor output P0 may be set to the value of the average motor output for the latest one pedal rotation.

Further, if the pedaling has been stopped (“Yes” at step S5) and the brakes are released (“Yes” at step S6), the drive controller 5 sets the control mode to the gradual decrease mode, which is one example of the automatic control mode (S7). The drive controller 5 calculates the motor output in the gradual decrease mode (S8), and causes the motor to perform an output (S9). For example, at step S8, for example, a target value of the motor output is calculated, and a motor command value to bring the motor output closer to the target value is calculated. At step S9, the drive controller 5 causes the motor 3 to operate at the motor command value calculated at step S8. For example, the drive controller 5 supplies the motor driving unit 53 with the motor command value to drive the motor 3.

In the implementation of FIG. 5, the preconditions for disablement of automatic control (i.e., termination of automatic control) are: (Precondition 3′) pedaling performed; (Precondition 4′) the brakes operated; and (Precondition 7) the current vehicle speed Vn being lower than the termination vehicle speed (i.e., lower limit of vehicle speed) VF (Vn<VF). That is, if pedaling is being performed or the brakes are being operated (“No” at step S5 or S6), the control mode transitions from the gradual decrease mode to the normal assist control mode (S11). Further, even if the preconditions to initiate the automatic control are not met, that is, if the automatic control switch is off or the set vehicle speed has not been reached (“No” at step S1 or S2), the control mode is set to the normal assist control mode (S11).

In the normal assist control mode, the pedal force (i.e., torque) In and vehicle speed Vn are detected (S12). The drive controller 5 calculates the motor torque command value depending on the detected pedal force Tn and vehicle speed Vn (S13) and, based on the motor torque command value, causes the motor 3 to perform an output that depends on the command value (S14). At step S13, for example, if the pedal force Tn is zero, a command value is calculated that will result in a motor torque of zero. This provides a control that provides a driving force generated by the motor 3 only when there is a pedal force Tn.

The processes of steps S5 to S9 are repeated until the current vehicle speed Vn becomes lower than the termination vehicle speed (i.e., lower limit of vehicle speed) VF (“Yes” at step S10). When the current vehicle speed Vn becomes lower than the termination vehicle speed VF (“Yes” at step S10), the drive controller returns to step S1 and performs its processes. The termination vehicle speed VF is set to a value lower than the set vehicle speed Vs (VF<Vs). Thus, after “Yes” at step S10 and the unit returns to step S1, “No” applies at step S2 and the control mode transitions to the normal assist control mode (step S11).

FIG. 6 is a flow chart illustrating an exemplary process for calculating the output in the gradual decrease mode (step S8 in FIG. 5), using a motor output (i.e., motor torque) as a target value. In the implementation of FIG. 6, if the current vehicle speed V(n) is lower than the vehicle speed V from the previous calculation, V(n−1) (V(n)>Vn−1) and the current vehicle speed V(n) is above the reference vehicle speed V0 (V(n)>V0) (i.e., “No” at steps 21 and 22), the drive controller 5 controls the motor output by updating the target value of motor output (step S23). At step S23, for example, the target value of motor output P(n) is updated to a value that is lower than the target value from the previous calculation, P(n−1), by a predetermined amount ΔP. It will be understood that the initial target value of motor output, P(0), may be equal to the reference motor output P0. A motor command value I(n) for bringing the motor output closer to this target value P(n) is calculated (S24). At step S24, for example, a command value for achieving the target value P(n) with PI control is calculated. The calculated motor command value I(n) is output as a return value (step S25). By way of example, the motor command value is a motor current command value.

In the implementation of FIG. 6, if V(n)>V(n−1) or V(n)>V0, that is, if “Yes” at step S21 or S22, the calculation gives the motor command value I(n)=0 (step S26). In this case, the motor 3 stops. Thus, in the implementation of FIG. 6, the preconditions to disable automatic control (i.e., interrupting automatic control, that is, stopping the motor) that are set are: (Precondition 5) the vehicle being accelerated (V(n)>V(n−1)) and (Precondition 6) the current vehicle speed V(n) being higher than the reference vehicle speed V0 for automatic control (V(n)>V0). It will be understood that, at point A1 in FIG. 6, the same process as the motor output control of step S23 (P(n)=P(n−1)−ΔP) may be performed. It will be understood that the motor output to be controlled is not limited to motor torque, and may be motor rotation speed, for example.

FIG. 7 is a flow chart illustrating an exemplary process for calculating the output in the gradual decrease mode (step S8 in FIG. 5), using a vehicle speed as a target value. In FIG. 7, the processes of steps S21, S22 and S25 may be performed in the same manner as in FIG. 6. At step S23a, the drive controller 5 performs the vehicle speed control process by updating the target value of vehicle speed (S23a). At step S23a, for example, the target value of vehicle speed V(n) is updated to a value that is lower than the target value of the previous calculation V(n−1) by a predetermined amount ΔV. It will be understood that the initial target value of vehicle speed, V(0), may be equal to the reference vehicle speed V0. At step S24a, a motor command value I(n) for bringing the vehicle speed closer to this target value V(n) is calculated. At step S24a, for example, a command value for achieving the target value V(n) with PI control is calculated. In the implementation of FIG. 7, similar to that of FIG. 6, the preconditions to disable automatic control (i.e., interrupting automatic control) that are set are: (Precondition 5) the vehicle being accelerated (V(n)>V(n−1)) and (Precondition 6) the current vehicle speed V(n) being higher than the reference vehicle speed for automatic control V0 (V(n)>V0). Further, at point A1 in FIG. 7, the same process as the vehicle speed control of step S23a (V(n)=V(n−1)−ΔV) may be performed.

The automatic control process by the drive controller 5 is not limited to the implementations shown in FIGS. 5 to 7. For example, at step S6 in FIG. 5, in addition to the determination as to whether the brakes are released (i.e., whether the brakes are being operated), the duration time of a braking operation may be determined. For example, at step S6, a braking operation may be detected and it may be determined whether the duration time of the braking operation, tB, is less than a threshold ThB (tB<ThB). In such implementations, if a braking operation is detected and tB<ThB (“Yes” at step S6), the processes of steps S7 to S9 are performed. Thus, a braking operation by the rider continuing for a predetermined period of time or longer is set as a precondition to disable automatic control.

In the implementation of FIG. 5, the reference motor output P0 at step S4 is based on a motor output value. In a variation, the reference motor output P0 may be based on a motor output value and a pedal force. For example, the reference motor output P0 at step S4 may be the sum of the latest peak motor output and peak pedal force. Alternatively, P0 may be the sum of the average motor output value and average pedal force for the latest one pedal rotation. It will be understood that, if such a sum is larger than the maximum output of the motor 3, the maximum output of the motor 3 may be used as the reference motor output P0. As a result, the reference motor output P0 is larger. Thus, during automatic control, a gradual decrease control of vehicle speed may be initiated with a large motor output within a range that does not cause an increase in speed due to the driving force by the motor 3.

The process for calculating the output in the gradual decrease mode shown in FIGS. 6 and 7 may be cyclically repeated to reduce the motor output or vehicle speed by a constant amount (ΔP or ΔV) for each cycle, i.e., per unit time. The gradual decrease during automatic control is not limited to such a linear decrease. For example, a mapping data indicating the manner of the gradual decrease may be used to update the target value of motor output or vehicle speed at steps S23 and S23a. The mapping data may be, for example, data indicating the correspondence between the elapsed time or travel distance for the automatic control process and the target value. The mapping data may be stored in the memory in the drive controller 5 in advance.

In the implementation of FIG. 5, the rider is able to indicate whether automatic control is permitted or not by operating the automatic control switch, which is an example of the operation element 37, between on and off. A variation of the operation element 37 may be a switch, a lever, or a button that switches between the gradual decrease mode and the vehicle speed maintaining mode of the automatic control. The process for the vehicle speed maintaining mode includes, for example, setting the control mode to the vehicle speed maintaining mode at step S7 in FIG. 5, and performing the output calculation in the vehicle speed maintaining mode at step S8. The output calculation in the vehicle speed maintaining mode may be, for example, a process that uses the reference vehicle speed V0 as a target value of vehicle speed and calculates a motor command value that will cause the vehicle speed to reach the target value. Alternatively, the output calculation in the vehicle speed maintaining mode may be a process that uses the reference motor output P0 as a target value and calculates a motor command value that will cause the motor output to reach the target value.

In the gradual decrease mode, the rider may be able to designate a rate of decrease in vehicle speed. For example, the operation element 37 may be used to switch the rate of decrease in vehicle speed among a plurality of levels or set the rate in a continuous manner. The drive controller 5 sets the amount ΔP in FIG. 6 or ΔV in FIG. 7 depending on the rate of decrease in vehicle speed designated by the rider. By way of example, in implementations where the rate of decrease in vehicle speed can be switched among three levels, namely “strong”, “intermediate” and “weak”, a designation of “strong” may indicate ΔP=ΔP1, a designation of “intermediate” ΔP=ΔP2, and a designation of “weak” Δ=Δ3, where Δ1<Δ2<Δ3.

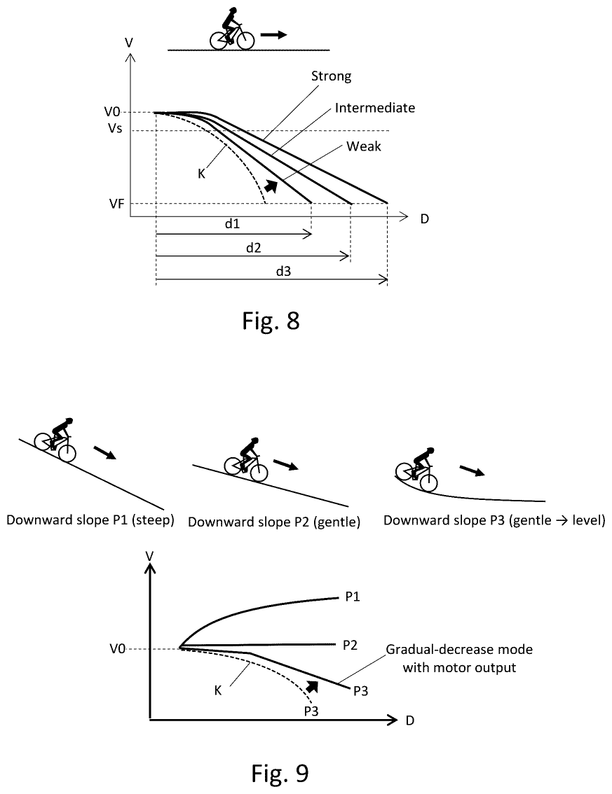

FIG. 8 is a graph illustrating patterns of changes in vehicle speed over time in the gradual decrease mode when the rate of decrease in vehicle speed is set to “strong”, “intermediate”, and “weak”, respectively. The vertical axis of the graph indicates the vehicle speed V, whereas the horizontal axis indicates the travel distance D. A solid line in the graph indicates a pattern of changes in vehicle speed when the automatic control is performed, whereas the broken line K, for reference, indicates a pattern of changes in vehicle speed when an inertial travel without a motor driving force nor pedaling occurred from the vehicle speed at the time of the initiation of automatic control. These graph definitions also apply to FIGS. 9 to 11. FIG. 8 illustrates cases where the vehicle 10 is traveling on a level road. In the cases shown in FIG. 8, the inertial travel distances due to the driving force from the motor 3 during automatic control when the rate of decrease in vehicle speed is set to “weak”, “intermediate”, and “strong”, d1, d2, and d3, respectively, are in the relationship of d1<d2<d3. The initial travel distance is a distance that can be traveled without pedaling by the rider during automatic control.

FIG. 9 is a graph illustrating patterns of changes in vehicle speed over time when the vehicle 10 is traveling on downward slopes during automatic control. In the cases in FIG. 9, on a steep downward slope P1, the vehicle speed increases, resulting in “Yes” at step S21 in FIGS. 6 and 7, i.e., (V(n)>V(n−1)), and the motor is stopped (i.e., automatic control interrupted). Or, if a set upper limit of vehicle speed is set as a precondition to disable automatic control, the motor can be stopped to interrupt automatic control for the period of time in which the vehicle is on a downward slope and the vehicle speed is not lower than the set upper limit of vehicle speed, as is the case with P1 in FIG. 9. On a gentle downward slope P2, the vehicle speed exceeds V0 and then becomes constant (“Yes” at step S22), stopping the motor (i.e., interrupting automatic control). On a gentle downward slope and then a level road P3, the period of time for which the vehicle is traveling on the level road gives “No” at steps S21 and S22, and the motor 3 is automatically controlled to perform an output in the gradual decrease mode. A precondition to initiate the automatic control that is set may be a threshold value of the downward slope. The downward slope on which the vehicle 10 is traveling may be determined based on a signal from the acceleration sensor, for example.

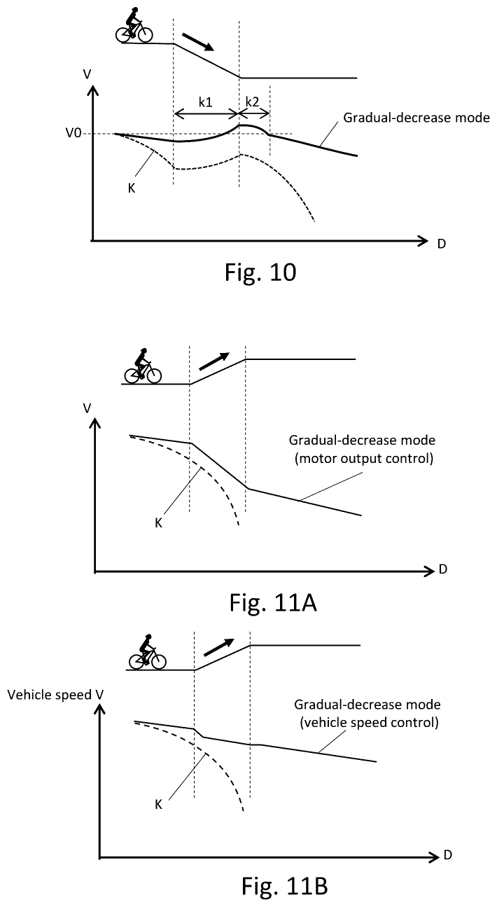

FIG. 10 is a graph illustrating patterns of changes in vehicle speed over time when the vehicle 10 is traveling on a level road, a downward slope, and then another level road during automatic control. In FIG. 10, section k1 with a speed increase on the downward slope and the section k2 on the subsequent level road with a vehicle speed higher than V0 indicate “Yes” at step S21 in FIGS. 6 and 7 and “Yes” at step S22, stopping the motor. When the vehicle speed reaches the reference vehicle speed V0 on the level road after the downward slope, automatic control with output in the gradual decrease mode is resumed.

FIGS. 11A and 11B show graphs illustrating patterns of changes in vehicle speed over time when the vehicle 10 is traveling on a level road, an upward slope, and then another level road during automatic control. FIG. 11A is a graph for the motor output control shown in FIG. 6. FIG. 11B is a graph for the vehicle speed control shown in FIG. 7. In the case in FIG. 11A, the rate of decrease in motor output is controlled on the upward slope in the same manner as on the level road. Thus, the rate of decrease in vehicle speed on the upward slope is higher than on the level road. In the case in FIG. 11B, at the beginning of the upward slope, vehicle speed decreases momentarily. The control in the gradual decrease mode is continued, the decrease in vehicle speed notwithstanding. When the vehicle moves from the upward slope to the level road and the vehicle speed increases momentarily, this indicates “Yes” at step S21 in FIG. 7, stopping the motor. Thereafter, when the vehicle speed begins to decrease again, a motor drive in the gradual decrease mode is resumed. For the vehicle speed control in FIG. 11B, the total inertial travel distance using automatic control in the gradual decrease mode is longer than for the motor output control in FIG. 11A.

Starting from the cases of FIGS. 9 to 11A and 11B, an upward slope may be replaced by a head wind, a road surface resistance (e.g., rain, mud, or sand), or any other event that increases running resistance, and the same patterns of changes in vehicle speed will be provided. Similarly, a downward slope may be replaced by a tail wind or any other event that decreases running resistance, and the same patterns of changes in vehicle speed will be provided.

In lieu of an electric motor assisted bicycle, the human driven vehicle according to example embodiments of the present invention may be an electric bicycle or a pedaled electric motorcycle (i.e., electric moped), for example. Further, the human driven vehicle is not limited to a two-wheeled vehicle, and may be vehicle with three or more wheels.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vehicle comprising:
a plurality of wheels;
a motor to supply at least one of the plurality of wheels with a driving force;
a pedal to receive input of a pedal force applied by a rider to drive at least one of the plurality of wheels;
a vehicle speed sensor to detect a vehicle speed; and
a drive controller configured or programmed to control driving of the motor; wherein
the drive controller is configured or programmed to perform an automatic control using the driving force from the motor alone when at least a first precondition is met in which the rider is riding the vehicle and traveling, and the vehicle speed detected by the vehicle speed sensor has reached a set speed by acceleration being not only due to a driving force from the motor.

2. The vehicle according to claim 1, wherein the first precondition is that the vehicle speed has reached the set speed at least due to the pedal force applied by the rider.

3. The vehicle according to claim 1, wherein the automatic control maintains the vehicle speed constant using the driving force from the motor or controls a rate of decrease in the vehicle speed using the driving force from the motor.

4. The vehicle according to claim 1, wherein the drive controller is configured or programmed to perform the automatic control if the first precondition is met and the rider has performed an operation to command the automatic control.

5. The vehicle according to claim 1, wherein the drive controller is configured or programmed to perform the automatic control if the first precondition is met and pedaling by the rider on the pedal has stopped.

6. The vehicle according to claim 1, wherein
the drive controller is configured or programmed to disable the automatic control if a precondition for disablement is met during the automatic control; and
the precondition for disablement includes at least one of detection of braking, detection of a pedal force on or rotation of the pedal, a disablement operation by the rider on an operation element, the vehicle speed reaching a set upper limit, the vehicle speed reaching a set lower limit, detection of a disturbance, detection of a vehicle speed increase, passage of a set duration time, or detection of curve traveling.

7. The vehicle according to claim 1, wherein, during the automatic control, the drive controller is configured or programmed to perform a control of the vehicle speed with respect to a reference vehicle speed, the reference vehicle speed being a vehicle speed when the first precondition is met and then pedaling by the rider on the pedal stops or rotation of the pedal stops.

8. A vehicle comprising:
a plurality of wheels;
a motor to supply at least one of the plurality of wheels with a driving force;
a pedal to receive application of a pedal force applied by a rider to drive at least one of the plurality of wheels;
a torque sensor to detect the pedal force on the pedal; and
a drive controller configured or programmed to control driving of the motor; wherein
the drive controller is configured or programmed to perform an automatic control using the driving force from the motor alone when at least a first precondition is met in which the pedal force detected by the torque sensor has reached a set level.

9. The vehicle according to claim 8, wherein the automatic control maintains the vehicle speed constant using the driving force from the motor or controls a rate of decrease in the vehicle speed using the driving force from the motor.

10. The vehicle according to claim 8, wherein the drive controller is configured or programmed to perform the automatic control if the first precondition is met and the rider has performed an operation to command the automatic control.

11. The vehicle according to claim 8, wherein the drive controller is configured or programmed to perform the automatic control if the first precondition is met and pedaling by the rider on the pedal has stopped.

12. The vehicle according to claim 8, wherein
the drive controller is configured or programmed to disable the automatic control if a precondition for disablement is met during the automatic control; and
the precondition for disablement includes at least one of detection of braking, detection of a pedal force on or rotation of the pedal, a disablement operation by the rider on an operation element, the vehicle speed reaching a set upper limit, the vehicle speed reaching a set lower limit, detection of a disturbance, detection of a vehicle speed increase, passage of a set duration time, or detection of curve traveling.

13. The vehicle according to claim 8, wherein, during the automatic control, the drive controller is configured or programmed to perform a control of the vehicle speed with respect to a reference vehicle speed, the reference vehicle speed being a vehicle speed when the first precondition is met and then pedaling by the rider on the pedal stops or rotation of the pedal stops.

14. A drive control apparatus for controlling driving of a motor of a vehicle including a plurality of wheels, the motor to supply at least one of the plurality of wheels with a driving force, a pedal to receive input of a pedal force applied by a rider to drive at least one of the plurality of wheels, and a vehicle speed sensor to detect a vehicle speed, drive control apparatus comprising:
a drive controller configured or programmed to control driving of the motor; wherein
the drive controller is configured or programmed to perform an automatic control using the driving force from the motor alone when at least a first precondition is met in which the rider is riding the vehicle and traveling, the vehicle speed detected by the vehicle speed sensor has reached a set speed by acceleration being not only due to a driving force from the motor.

15. A drive control apparatus for controlling driving of a motor of a vehicle including a plurality of wheels, the motor to supply at least one of the plurality of wheels with a driving force, a pedal to receive input of a pedal force applied by a rider to drive at least one of the plurality of wheels, and a torque sensor to detect the pedal force on the pedal, the drive control apparatus comprising:
a drive controller configured or programmed to control driving of the motor; wherein
the drive controller is configured or programmed to perform an automatic control using the driving force from the motor alone when at least a first precondition is met in which the pedal force detected by the torque sensor has reached a set level.
